(19) United States
(12) Patent Application Publication
(10) Pub. No.: US 2012/0228398 A1
(43) Pub. Date: Sep. 13, 2012

(54) DEVICE AND METHOD FOR CREATION OF A HYDRAULIC JUMP, NOTABLY A FOUNTAIN OR SWIMMING POOL

(75) Inventor: Thierry FOGLIZZO, Chevreuse (FR)

(73) Assignee: Comm. a l' ener. atom. et aux energies alter., Paris (FR)

(21) Appl. No.: 13/045,019

(22) Filed: Mar. 10, 2011

(51) Int. Cl. B05B 17/08; E04H 4/14; F15D 1/00

(52) U.S. Cl. 239/17; 137/561 R; 137/1; 4/491

(57) ABSTRACT

A hydraulic jump (1) is created at the free surface (2) of a liquid subjected to a flow over a surface (23) which declines towards a liquid outlet region, and where the supply is made by the overflow of a supply system (3), and where an element (24) rises above the flow surface (23) to form a retention volume (27) of the liquid before it is drained. The liquid may be recycled. The jump (1) may or may not be stable. The invention may be applied to the creation of artificial waves for simulation devices, ornamental fountains or swimming pools.

### TECHNICAL FIELD

The subject of this invention is a device and method for creation of a hydraulic jump; or again, more generally, for creation of a fluid jump, since the jump phenomenon is not restricted to liquids, and can be applied also to heavy gases in a lighter atmosphere. The device could then be for decorative use, such as simulations of waves, or scientific use, for performing certain experiments. Fountains and swimming pools may be cited as tangible applications.

A hydraulic jump is a sudden variation of the level of the free surface of a liquid (or of a gas). It is a sudden transition from a high-speed flow characteristics to subcritical characteristics.

### GENERAL ACCOUNT OF THE INVENTION

The invention enables such a jump to be created with a very simple device.

Particular objects of the invention are the management of settings which enable the characteristics of the jump to be regulated, and also particular means contributing to favourable embodiments of the device.

The hydraulic jump phenomenon is already known, but the conditions under which it is produced generally consist in allowing a flow-line of sufficient height to flow over a horizontal surface: a rise in the level of the liquid to a determined radius of the falling point of the liquid is then observed. Such devices and methods seem practicable only on a very small scale; otherwise the flow rate and falling height required to produce a sufficient load in the liquid or a jump of notable size would have to be completely excessive. Nor do they lend themselves to an adjustment of the parameters of the jump.

It should be added that non-circular jumps, ones which are polygonal or with lobes for example, of a few centimetres of diameter, have also been obtained by subjecting the flow to particular conditions, notably by allowing it firstly to flow in a tube, the lower end of which was a nozzle: the shape of the jump depended on the diameter of the nozzle's tip. It was, however, observed that these shapes were often unstable, and that they also depended on the surface tension of the liquid, which limits these phenomena to installations of roughly one centimetre in size. It is, furthermore, manifest that such devices with nozzles do not easily lend themselves to adjustments of the conditions of the flow and of the parameters of the jump.

Lastly, it is known that hydraulic jumps appear at the junction of torrential flows and river flows in nature or downstream from dams. The jumps then observed are normally turbulent, unstable, of irregular shape, and have particularly large quantities of air bubbles: they therefore have no decorative value, and only occasionally lend themselves to leisure applications, such as the surf on tidal bores at spring tides. Adjustment of their parameters is not as yet conceivable.

The use of the invention will, conversely, enable hydraulic jumps having desired characteristics of shape, dimensions and stability to be obtained easily, and enable these characteristics to be adjusted easily, notably in such a way as to change their shape, changing from a regular shape, circular for example, to an irregular shape, polygonal for example, or vice versa, and from a stable jump to an unstable jump, or vice versa.

In a general form, the invention concerns a device for creating a hydraulic jump, including a bottom surface able to be occupied by a circulating fluid, where the bottom surface extends between a region where the fluid enters and a region where the fluid leaves, and which declines from the inlet region to the outlet region, and also including a low wall attached to the bottom surface in the area of the fluid outlet region extending above the bottom surface, and having an upper edge for the fluid overflow, and an element for draining the fluid separated from the bottom surface by the wall; the device may be, among other applications, a fountain or a swimming pool; when the bottom surface is occupied by a circulating fluid the jump is produced notably between the inlet region and the outlet region. Depending on the circumstances, the jump may or may not be stable (immobile in the device). If it is unstable its position is generally oscillating or periodic in the device.

Typically, the device allows the a convergent circulation of the fluid to be established, from the inlet region to the outlet region.

It is frequently the case that the device is annular, the fluid outlet region being surrounded by the inlet region, and both being circular: the jump is then a circular line. This definition must, however, not be understood too strictly, since regions with irregular circle shapes, elliptical shapes for example, give comparable results, as do regions which are not closed, but which extend only over parts of circles, for example: the characteristic which it is desirable to establish is a convergent flow, favouring the creation of a jump of notable height, over a region of small width, or a width which is much smaller than the width of the fluid inlet region, with options of adjusting the characteristics of the jump more easily.

The function of the inlet region is to supply the fluid at a sufficient flow rate and speed. This speed may be acquired by gravity when the inlet region is formed by a second wall, attached to the bottom surface, extending above the bottom surface, and having an upper edge for fluid overflow, and an element for introducing the fluid which is separated from the bottom surface by the second wall.

The inlet region may also be produced by a slit extending above the bottom surface, but possibly at a low height, and the fluid energy is then acquired by restricting the pressurised flow through the slit.

One of the means for adjusting the characteristics of the flow, in order to adjust those of the jump, may then consist having an upper plate determining the slit by forming an upper limit of the slit, where the device also has means for adjusting the height of the upper plate and the thickness of the slit.

The bottom surface will often have an inclination increasing from the fluid inlet region to the fluid outlet region, for example a hyperbolic function the height of which is a function of a position between the fluid inlet region and the fluid outlet region.

The device may operate as a closed circuit, including a pump and extending between the liquid outlet region and the liquid inlet region. The pump will then advantageously be adjustable in order to adjust the flow rate of the liquid.

In the frequent case of a device with a large width, in which the jump will extend over a substantial length, an attempt will often be made to equal the jump over a regular line of constant distance between the fluid's inlet region and outlet region. And the closed circuit will generally consist of pipes ending at concealed locations in the fluid inlet region; but the flow may nevertheless be standardised by means of a flow distribution bed built from a porous material, in front of which will be the pipes' outlets.

In other circumstances, on the contrary, a jump of irregular shape will be sought. A means of constructing it will then consist in having obstacles in a concealed manner at certain locations in the direction of the breadth of the device such that they intercept separate portions of the fluid flow, and such that they therefore create irregularities in the flow.

In certain cases an attempt will be made to give the injected fluid a transverse speed component, for example in order to cause a rotational movement if the injection is annular. Guide rudders consisting of vertical plates, positioned all along the inlet region, may be swiveled in order to adjust, spatially and temporarily, the direction of the injected fluid.

Particular obstacles will consist of variations of height of the upper plate if the fluid inlet region is a slit: the upper plate will then be flexible, and the means for adjusting its height will include multiple separate means, which will be adjustable independently.

Other ways of adjusting the characteristics of the jump will consist in constructing the device in mutually separate mobile parts: thus, the wall may be vertically mobile relative to the bottom surface and, in a comparable manner, the fluid inlet region may belong to a part which is vertically mobile relative to the bottom surface, in order that its height may be adjusted.

The invention also relates to a method for creating a hydraulic jump consisting in pouring a fluid on an upper part of an inclined surface, in creating a flow over the inclined surface, and in creating a containment of a volume of the fluid at a lower part of the inclined surface.

The jump may be stationary or unstable, as has previously been mentioned. In this latter case, with an annular inclined surface, the jump may consist of a closed line, which is off-centre relative to the inclined surface, and which swivels.

Other aspects, details and characteristics of the invention will now be described with reference to the figures, which are given for illustration only, in order to represent completely certain possible embodiments of the invention.

### LIST OF FIGURES

FIGS. 1 and 2 represent a first embodiment of the invention as a diametral section, seen from above;

FIGS. 3 and 4 represent two possible jump shapes;

FIGS. 5, 6, 7, 8 and 9 represent a second embodiment of the invention, with two variants;

FIG. 10 illustrates a particular application of the invention;

FIG. 11 illustrates another embodiment of the invention; and

FIGS. 12, 13 and 14 illustrate devices for deflecting the flow.

### DESCRIPTION OF PREFERRED EMBODIMENTS

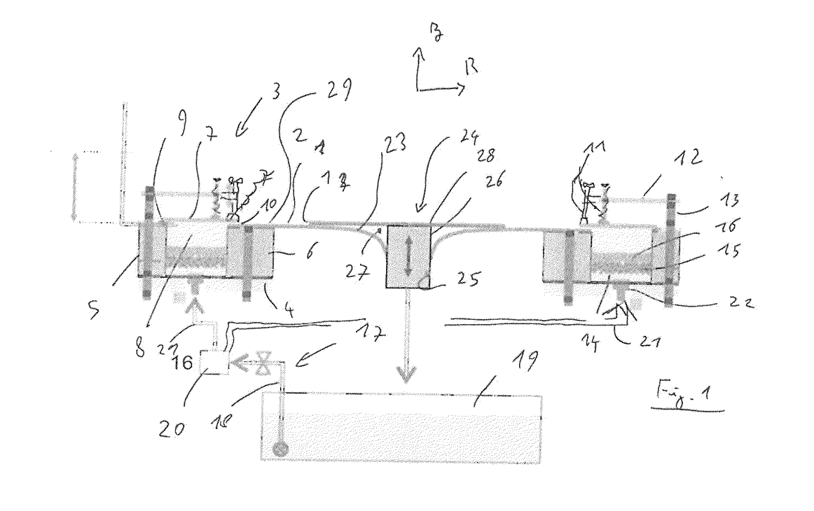

A first embodiment is represented in FIG. 1. The device is seen as a diametral section, and is circular in shape. It consists of four main elements, namely a liquid, an element through which the liquid enters, a surface over which the liquid flows, and an element for draining the liquid. Optional elements are a tank of the liquid, a liquid distribution circuit and a pump. The liquid flows from the injection element to the drainage element over the flow surface forming a jump (1), i.e. a sudden rise in the level of the free surface (2).

The inlet element (3) includes a bottom (4), concentric walls (5 and 6), and an upper plate (7), which demarcate a circular trench (8) occupied by the liquid. The upper plate (7) is attached to the outer wall (5) in watertight fashion by a silicon joint (9). It extends slightly above the inner wall (6) forming a circular slit (10). It is deformable and can be pressed downwards by rotating a number of threaded rods (11) held in place in captive nuts of brackets (12) suspended from threaded rods (13) fitted in the external wall (5). The pressing of the upper plate (7) produces a reduction of the thickness of the slit (10) and, for an equal flow rate of the liquid, an increase of its speed. The bottom of the trench (8) includes, spread over a grid (14), a lower bed (15) of clay balls and an upper bed (16) of gravel, which are used to spread the fluid flow rate over the perimeter of the slit (10). The distribution circuit (17) includes, indeed, a first pipe (18) leading from the tank (19) and ending at the pump (20), and distribution pipes (21) leading from the pump (20) and ending at valve nozzles (22) distributed across the bottom plate (4) but in insufficient numbers to provide a sufficiently uniform flow across the slit (10) without passing over the beds (15 and 16) made of porous material.

The flow surface (23) slopes downwards from the slit (10) as far as the liquid drainage element 524), which consists of a tube (25) positioned across a central hole of the flow surface (23), and which is positioned above the tank (19), which is open. The tube (25) is attached to the flow surface (23), rising above it, and thus forms a circular wall (26) creating a retention volume of the convergent flow. The liquid therefore flows over the flow surface (23) from an inlet region (slit 10) to an outlet region (the upper edge 28) which are concentric, it accumulates in the retention volume (27), and the conflict between the flowing liquid and the retained liquid is the cause of the jump (1); the liquid then leaves the flow surface (23) by overflowing the upper edge (28) of the tube (26) and by falling into the tube (26) and then into the tank (19), where it is recycled by the distribution circuit (17).

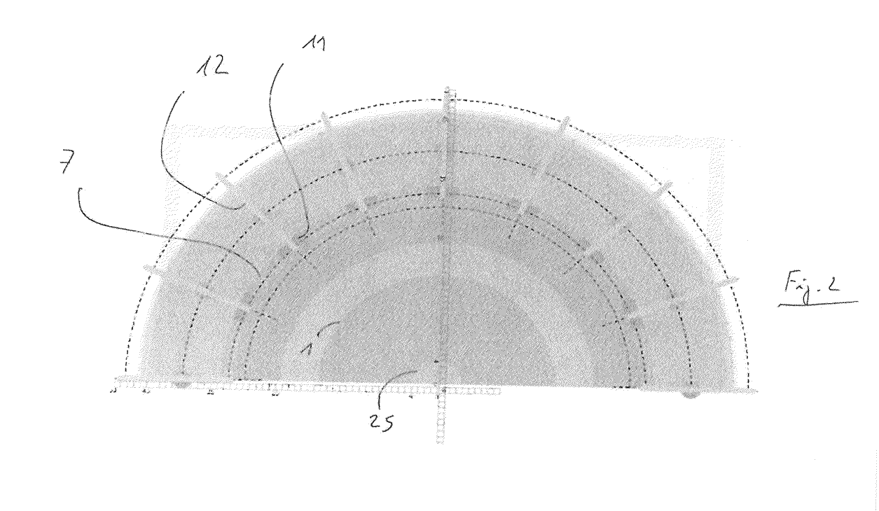

FIG. 2 is a view from above of the device, showing the circular or annular character of the main elements. The means of pressing, including the threaded rods (11), of the upper plate (7) are however concealed, and sixteen in number in this embodiment.

Except for the flat outer portion (29) connected to the top of the inner partition (6) and forming the slit (10), the flow surface (23) is hyperbolic in shape, and its height Z is inversely proportional to the radius R, to within the accuracy of a constant (Z=A−B/R).

The characteristics of the jump depend on the geometrical characteristics of the device and of the flow, notably the flow rate. If H is the depth of the flow at a determined radius R, the speed of the waves the wavelength of which is large compared to the depth is expressed by

c=\sqrt{(gH)}
where g is the gravitational constant, the flow rate by

Q=2πRHυ
where v is the flow speed of the liquid and the Froude number is equal to

Fr=|v|/c.

The appearance of the hydraulic jump (1) requires that the injected liquid attain a speed higher than that of the waves, or that the Froude number is greater than 1. The height of the jump is defined by heights H1 and H2 either side of the jump, by the formula

$$\frac{{H}_{2}}{{H}_{1}} = \frac{{( 1 + 8 {Fr}_{1}^{2} )}^{\frac{1}{2}} - 1}{2} ,$$

where Fr₁ is the Froude number at the location of the jump. The depth H₁ may be written

$${H}_{1} = \frac{Q}{{2}^{\frac{3}{2}} π {Rj ( g {H}_{pot} )}^{\frac{1}{2}}} ,$$

where

$${H}_{pot} = \frac{{v}_{1}^{2}}{2 g}$$

(height of freefall corresponding to the local speed) and Rⱼ is the radius of the jump (1). The characteristic period of the oscillations of the unstable jump (1) may be approximated by

$${τ}_{adv} ∼ \frac{{R}_{j} - {r}_{out}}{{v}_{2}} .$$

where rₒᵤₜ is the outer radius of the flow surface (23), at the location of the slit (10), and v₂ is the speed of the liquid downstream from the jump (1), or again

$${τ}_{adv} ∼ \frac{{R}_{j} - {r}_{out}}{{( 2 {gH}_{pot} )}^{\frac{1}{2}}} \frac{{H}_{2}}{{H}_{1}} .$$

The flow rate Q must be greater than

$${2}^{\frac{3}{2}} {g}^{\frac{1}{2}} π {R}_{j} {H}_{pot}^{\frac{3}{2}} .$$

The properties of the jump (1) change according to the value of the Froude number Fr and may be chosen in accordance with the desired characteristics:
from 1.7 to 2.5, the jump is weak and laminar;
from 2.5 to 4.5, it is transient and generates small waves;
from 4.5 to 9, it is balanced and stationary;
above 9 it is irregular and generates waves, splashes and bubbles.

The following approximate formulae may also be used:

$${H}_{1} \approx \frac{Q}{{R}_{j} {H}_{pot}^{\frac{1}{2}}} ;$$

$${H}_{2} \approx \frac{{Q}^{\frac{1}{2}} {H}_{pot}^{\frac{1}{4}}}{{R}_{j}^{\frac{1}{2}}} ;$$

$${τ}_{adv} \approx \frac{{R}_{j}^{\frac{3}{2}} {H}_{pot}^{\frac{1}{4}}}{{Q}^{\frac{1}{2}}} .$$

In terms of speed, with the criterion Fr>1 in the terrestrial gravitational field, it is possible to observe the hydraulic jump (1) for a satisfactory fluid flow rate in the relationship v²/h>10 m/s² on injection, where v therefore represents the speed of the liquid through the slit (10) and h the height of the latter. It has also been observed that the diameter of the hydraulic jump (1) is greater the greater the height of the wall (26). In a comparable fashion, a flow surface (23) which is very concave in its centre, and therefore having a substantial retention volume (27), leads to a longer oscillation time of the jump (1) than a surface which is almost flat. Convergent flows therefore have the advantage that they give greater stability with a smaller retention volume (27), since they extend over a smaller circle than with other flows.

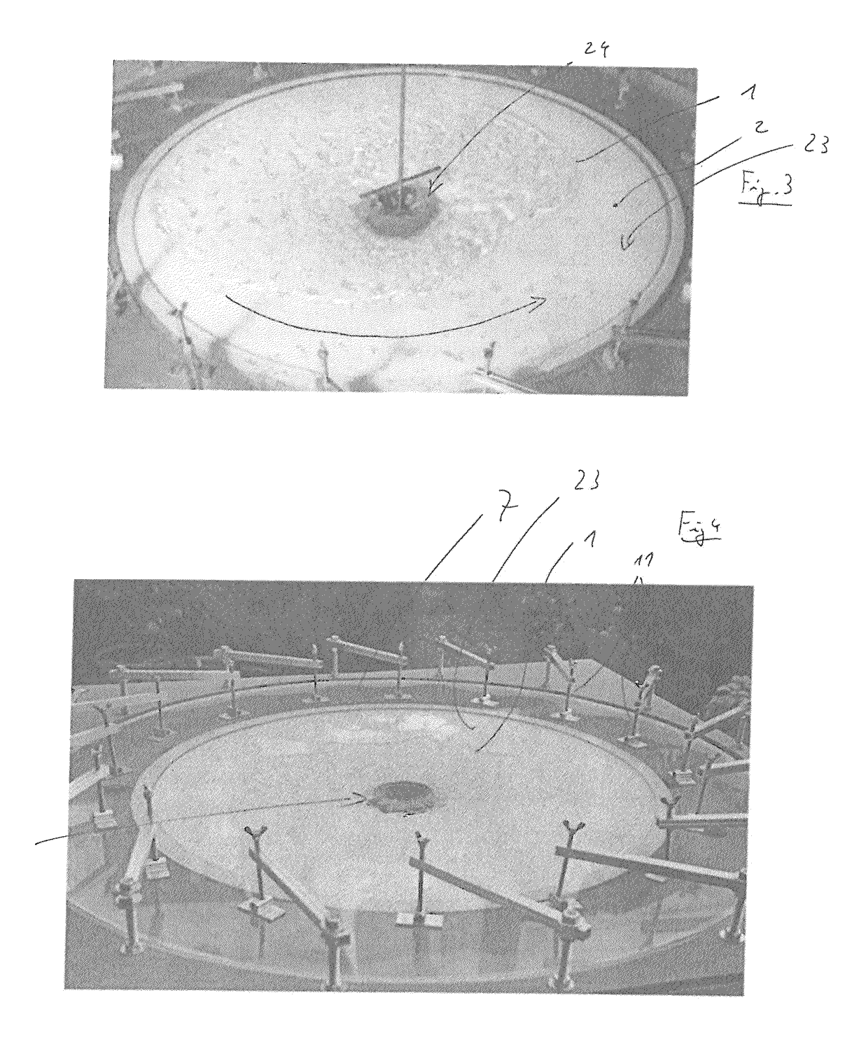

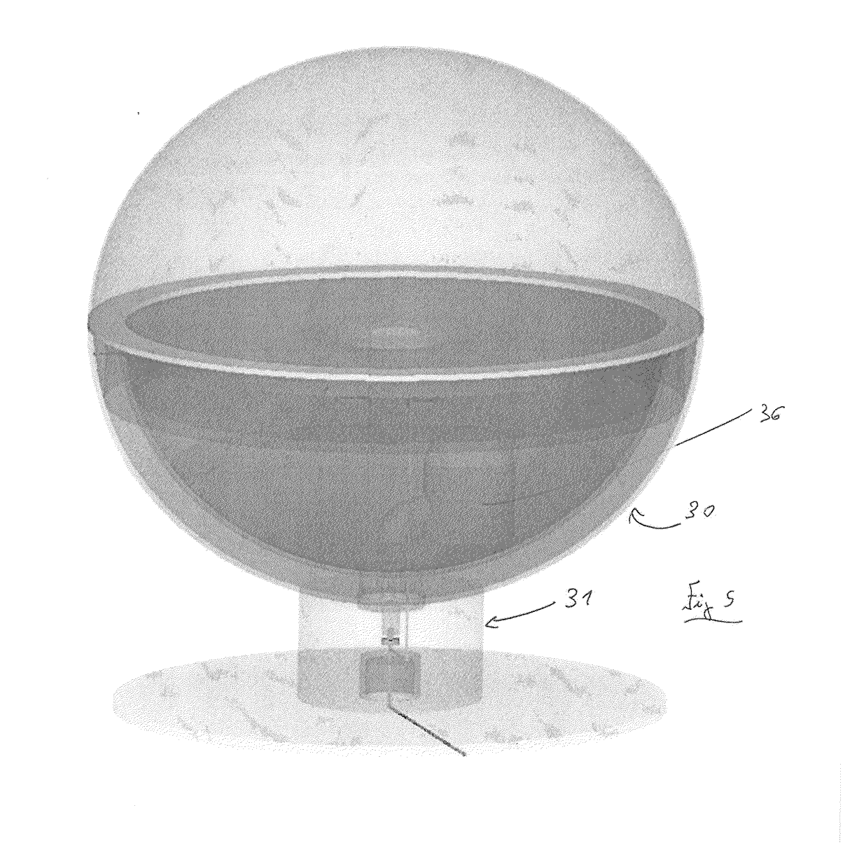

When the jump (1) is not stationary, above a critical value of the flow rate, it takes in this embodiment the appearance (FIG. 3) of a roughly circular continuous line but which is off-centre relative to the shaft of the device, and which is displaced while swiveling in the angular direction of the flow surface (23), such that each location of this surface regularly sees the jump (1) pass, rising and descending, except at the extreme radii. It is also possible (FIG. 4) to create non-circular jumps (1), by modifying the characteristics of the flow by means of local obstacles which disrupt its uniformity: if, for example, the upper plate (7) has a certain flexibility the slit (10) may be narrower under the threaded rods (11) than between them, which produces variations of the radius of the jump (1) and a star-shaped pattern.

Another embodiment will now be described by means of FIGS. 5 to 9. It includes two caps fitted into one another, which are nearly hemispherical in shape, and with a downwards-directed concavity. An outer cap (30) rests on a base (31). An inner cap (32) encloses the tank, now (33), and supports the flow device (34) and the liquid drainage element (35). A pump (36) is positioned in the tank (33) and forces backed the liquid which has fallen into it into the circular volume (37) between the caps (30 and 32), where it rises.

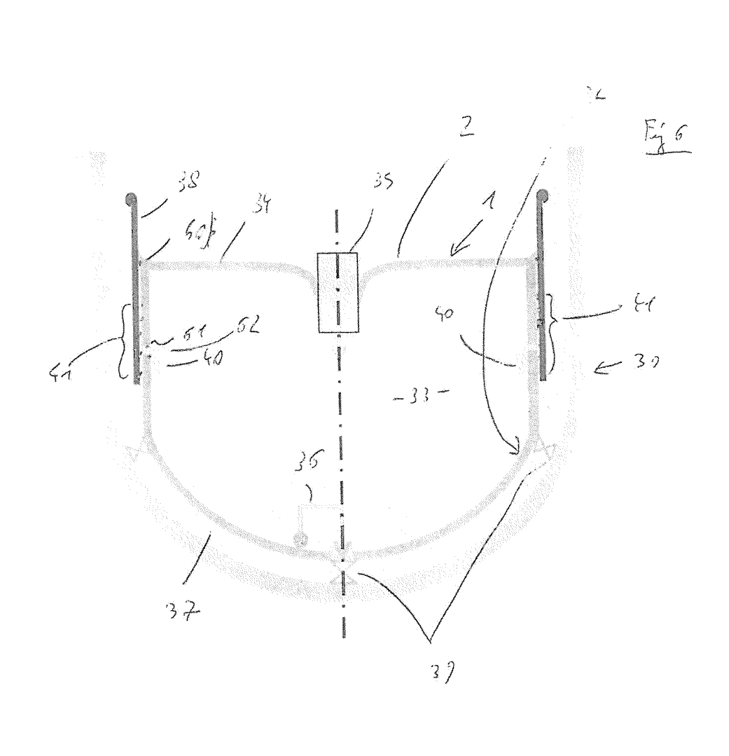

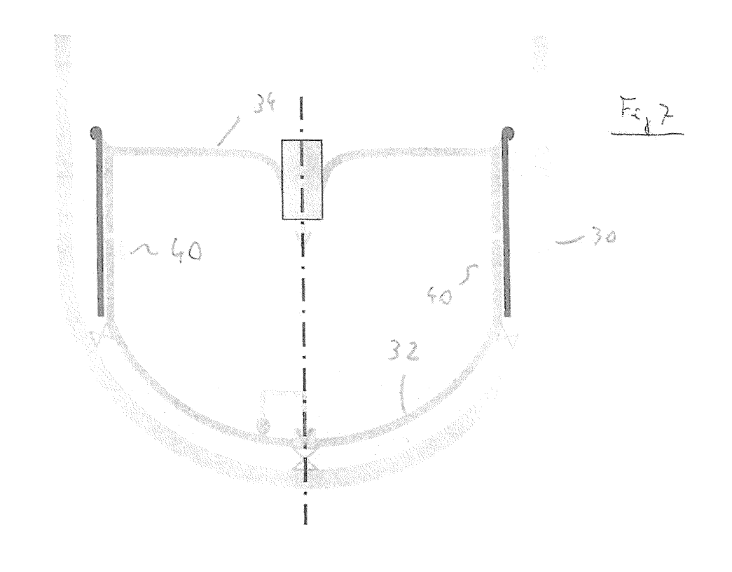

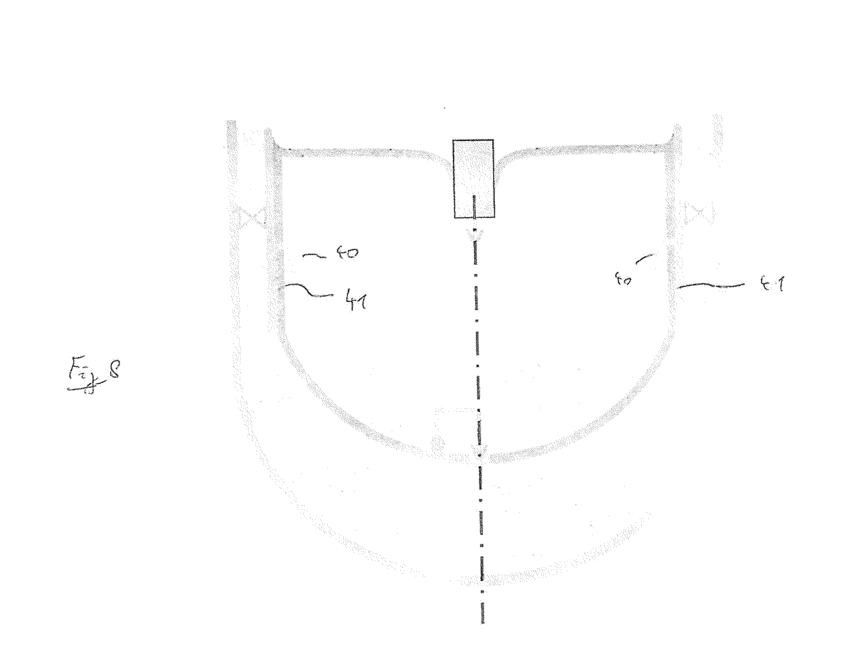

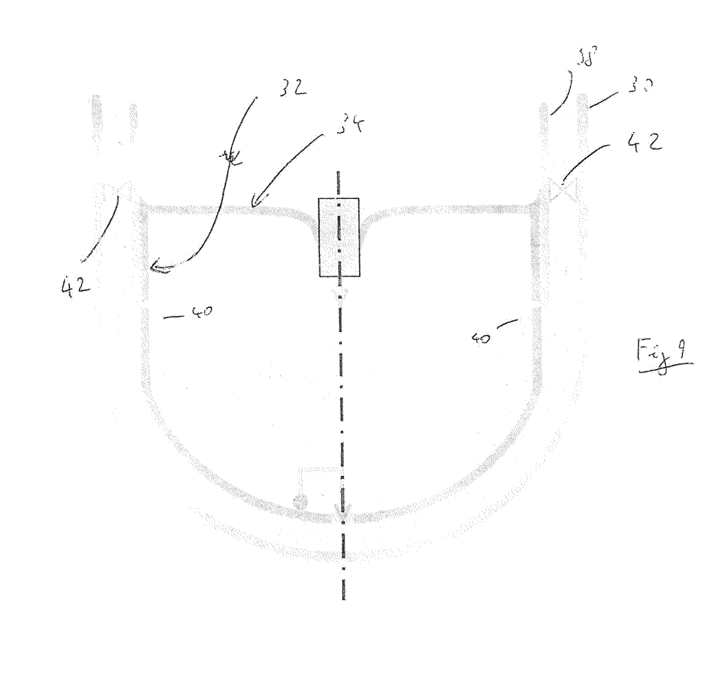

The top of the inner cap (32) is attached to an edge (38) which forms the fluid inlet element, and which extends above the flow surface (34). The surplus liquid overflows from the edge (38) and reaches the flow surface (34) with a speed which depends on the overhang height of the edge (38). The characteristics of the flow and of the jump (1) over the flow surface (34) are unchanged and depend on the same parameters as in the previous embodiment. An advantage of the present embodiment is that it is simple in shape and construction. Another advantage is that the height of the edge (38) relative to the flow surface (34), and therefore the liquid arrival speed, can be adjusted. In the embodiment of FIGS. 6 and 7, where the caps (30 and 32) are in invariable positions maintained by spacers (39), the edge (38) is screwed to the outside of the inner cap (32) and motors (40) adjust the top of the edge (38) by acting on vertical racks (41) established on the inner surface of the edge (38), beneath the flow surface (34), by unrepresented drive gears; joints (60) and (61) are positioned on the outside of the flow surface (34) facing the edge (38) and rubbing on it, and around transmissions (62) positioned at the outputs of the motors (40) and through the inner cap (32), which raises or lowers the edge (38) between the states of FIGS. 6 and 7. In the embodiment of FIGS. 8 and 9 spacers (42) connect the edge (38) to the outer cap (30), and it is the height of the inner cap (32) which varies with the rotation of the motor (40). The same effect of variation of the height of the edge (38) relative to the flow surface (34) is obtained.

FIG. 10 represents a possible application of the invention to a summing pool entirely excavated from the ground. The flow surface (43), having the shape of a funnel, is surrounded by a circular pit (44) where the water is recycled from pipes (45) fitted with pumps and radiating from a central well (47), which is the liquid drainage element, and from a short distance from which the flow surface (43) comes to an end. The pipes (45) lead into the circular pit (44), and the recycled water rises here until it overflows, and flows in the flow surface (43) as previously. A central platform (48) covers the well (47), and protective nets (49) stretched between the platform (48) and the flow surface (43) ensure that the bathers are kept separate from the orifice of the well (47). The platform (48) is suspended from an arrow-shaped footbridge (50) by which the bathers reach the swimming pool or leave it. Access may also be possible directly by the outside of the surface (43), which then serves as a toboggan.

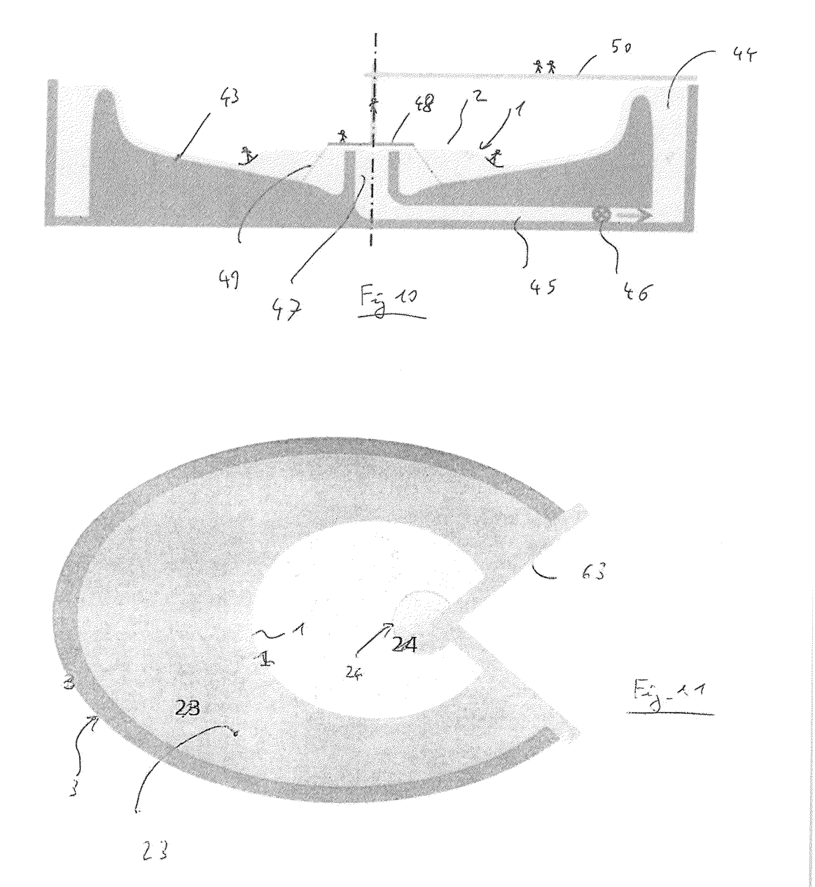

Several other optional characteristics of the invention will now be described. FIG. 11, which is a view from above of a device which is, furthermore, comparable to that of FIGS. 1 to 4 for example, shows that a convergent flow may be accomplished with an inlet element 3 which is simultaneously elliptical and extending over a sector of a circle, where the drainage element (24) also extends over a sector of a circle, and where both are limited by a vertical wall (63) in the shape of a corner which gives two lateral limits to the device and to the flow. The jump (1) once again has the shape of a continuous line, in this case a roughly elliptical line, surrounding the drainage element (24) from one of the sections of the vertical wall (63) to the other. The other characteristics of the method are not truly modified.

Other characteristics of the flow and of the jump can be modified by establishing an angular speed component for the fluid flow by means of rudders positioned in the liquid's inlet region. These rudders are particularly well adapted to the configuration with the slit (10) of FIGS. 1 to 4, across which the initial speed of the fluid is high. The rudders consist of panels which are regularly distributed around the circumference of the inlet element (3) and swiveling, generally in unison, around vertical shafts by means of motors (59). Special measures must however be taken when the slit (10) is of variable height: this is represented in the following figures.

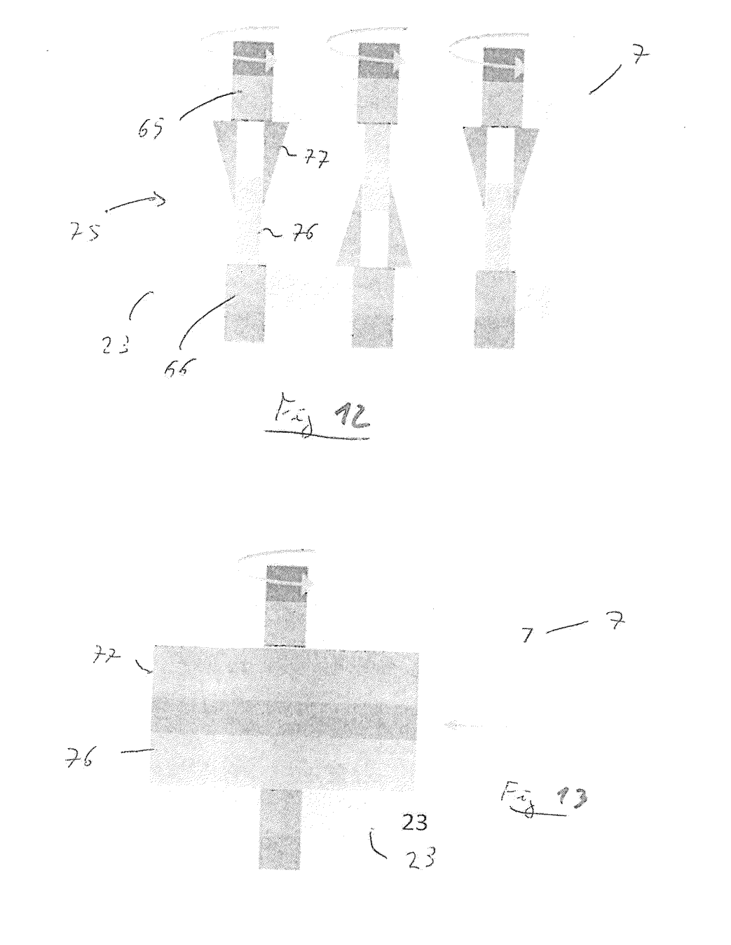

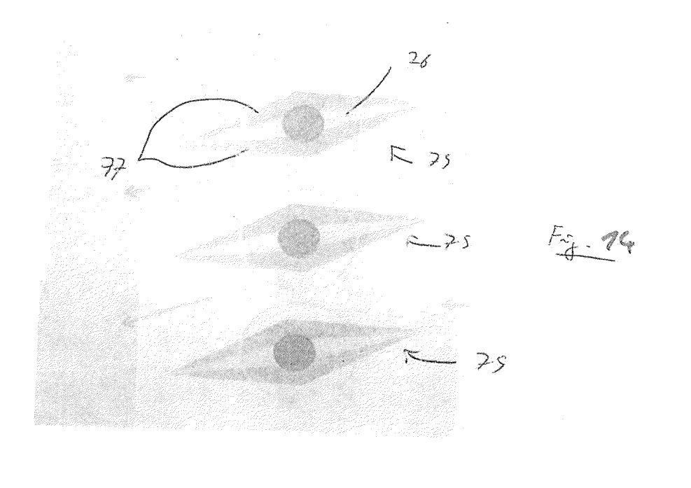

A slightly different embodiment is described by means of FIGS. 12, 13 and 14. The rudders (75) include rectangular panels directed horizontally, which are able to move but only with a horizontal travel movement. There is a simple panel (76) and a hollow panel (77) in which the previous one slides. In addition, panels (76) and (77) are alternatively attached to the upper shaft (65) and to the lower shaft (66) to limit the flow irregularities due to their different thicknesses. The panels (76) and (77) are attached to shafts (65) and (66) rigidly, their main edges are horizontal and their extreme edges are adjacent to the upper plate (7) and to the flow surface (23). The hollow panels (77) are thicker close to the shaft to which they are attached in order to have sufficient rigidity, but become thinner as they approach the full panels (76); all the panels (76) and (77) also become thinner in the fluid flow direction, the further they are from the shafts (65) and (66), as can be clearly seen in FIG. 14, in order not to disturb the flow excessively. More generally, such a device could be extended to include a larger number of panels positioned in a telescopic arrangement and sliding against one another (connected to their neighbours by vertical slides, for example) with both ends of the installation attached to the shafts (65) and (66).

1. A device for creating a hydraulic jump, including a bottom flow surface occupied by a circulating fluid, in which the flow surface extends between a region where the fluid enters and a region where the fluid leaves, and which declines from the inlet region to the outlet region, and also including a low wall attached to the flow surface in the area of the fluid outlet region, extending above the flow surface, and having an upper edge for the fluid overflow, and an element for draining the fluid separated from the flow surface by the wall.

2. A device for creating a hydraulic jump according to claim 1, in which the flow surface, the fluid inlet region, the fluid outlet region and the wall are concentric, and in which the fluid inlet region surrounds the fluid outlet region.

3. A device for creating a hydraulic jump according to claim 1, in which the inlet region is formed by a second wall, attached to the bottom surface, extending above the bottom surface, and having an upper edge for fluid overflow, and an element for introducing the fluid which is separated from the flow surface by the second wall.

4. A device for creating a hydraulic jump according to claim 1, in which the fluid inlet region is a slit extending above the bottom surface.

5. A device for creating a hydraulic jump according to claim 4, in which an upper plate defines the slit by forming an upper limit of the slit, and in which the device also has means for adjusting the height of the upper plate, and the thickness of the slit.

6. A device for creating a hydraulic jump according to claim 1, in which the flow surface has an inclination increasing from the fluid inlet region to the fluid outlet region.

7. A device for creating a hydraulic jump according to claim 6, in which the flow surface follows a hyperbolic function of height as a function of a position between the fluid inlet region and the fluid outlet region.

8. A device for creating a hydraulic jump according to claim 1, including a closed circuit of the fluid, including a pump, between the fluid outlet region and the fluid inlet region.

9. A device for creating a hydraulic jump according to claim 1, including means for adjusting the flow rate of the fluid.

10. A device for creating a hydraulic jump according to claim 8, in which the closed circuit includes pipes leading into the fluid inlet region, and the fluid inlet region includes a flow rate distribution bed built from porous material, in front of which are the pipes' outlets.

11. A device for creating a hydraulic jump according to claim 1, including obstacles to the fluid extending in certain locations by a widthways direction of the device in such a way as to intercept separate fluid flow positions.

12. A device for creating a hydraulic jump according to claim 5, in which the upper plate is flexible and the means for adjusting the height include multiple separate means which are independently adjustable.

13. A device for creating a hydraulic jump according to claim 1, in which the wall is vertically mobile relative to the bottom surface.

14. A device for creating a hydraulic jump according to claim 1, in which the fluid inlet region belongs to a part which is vertically mobile relative to the bottom surface.

15. A device for creating a hydraulic jump according to claim 2, in which the flow surface, the liquid inlet region, the liquid outlet region and the wall extend over sectors of a circumference, starting at a wall with the shape of a corner.

16. A device for creating a hydraulic jump according to claim 1, including means for adjusting the direction of the fluid, positioned in the fluid inlet region.

17. A device for creating a hydraulic jump according to claim 16, in which the means for adjusting the direction of the fluid are rudders, each swiveling around a vertical shaft, and distributed along the length of the fluid inlet region.

18. A device for creating a hydraulic jump according to claim 5, including means for adjusting the direction of the fluid, positioned in the fluid inlet region, in which the means for adjusting the direction of the fluid are rudders, each swiveling around a vertical shaft, and distributed along the length of the fluid inlet region, and the vertical shaft includes two separate parts engaged through the upper plate and the bottom surface, respectively, and the rudder also includes mutually assistive panels, respectively dependent on the parts of the shaft.

19. A device for creating a hydraulic jump according to claim 18, in which the panels are positioned in a telescopic system having ends which are respectively attached to the parts of the shaft, and sliding over one another.

20. A device for creating a hydraulic jump, including a surface intended to be occupied by a fluid, in which the surface extends between an opening intended for a fluid supply and a low wall, and declining from the opening to the wall, in which the wall rises above the surface, and is attached to the surface, and in which a fluid outlet is separated from the surface by the wall.

21. A fountain for creating a hydraulic jump, including a bottom flow surface occupied by a circulating fluid, in which the flow surface extends between a region where the fluid enters and a region where the fluid leaves, and which declines from the inlet region to the outlet region, and also including a low wall attached to the flow surface in the area of the fluid outlet region, extending above the flow surface, and having an upper edge for the fluid overflow, and an element for draining the fluid separated from the flow surface by the wall.

22. A swimming pool for creating a hydraulic jump, including a bottom flow surface occupied by a circulating fluid, in which the flow surface extends between a region where the fluid enters and a region where the fluid leaves, and which declines from the inlet region to the outlet region, and also including a low wall attached to the flow surface in the area of the fluid outlet region, extending above the flow surface, and having an upper edge for the fluid overflow, and an element for draining the fluid separated from the flow surface by the wall.

23. A method for creating a hydraulic jump, consisting in pouring a fluid on an upper part of an inclined surface, at a flow rate greater than a threshold, in creating a flow over the inclined surface, and in creating a containment of a volume of the fluid at a lower part of the inclined surface.

24. A method for creating a hydraulic jump according to claim 23, in which the jump is stationary.

25. A method for creating a hydraulic jump according to claim 24, in which the jump is unstable.

26. A method for creating a hydraulic jump according to claim 23, in which the flow is convergent over the inclined surface, the upper part of which is wider than the lower part.

27. A method for creating a hydraulic jump according to claim 26, in which the inclined surface is annular and the jump is a closed line, which is off-centre relative to the inclined surface, and swiveling.
